(19) United States
(12) Patent Application Publication
(10) Pub. No.: US 2014/0325064 A1
(43) Pub. Date: Oct. 30, 2014

(54) Controlling Establishment of Multiple TCP Connections

(71) Applicant: Telefonaktiebolaget L M Ericsson (publ), Stockholm (SE)

(72) Inventors: Ingemar Johansson, Lulea (SE); Mattias Åkervik, Kista (SE); Martin Skarve, Enebyberg (SE)

(73) Assignee: Telefonaktiebolaget L M Ericsson (publ), Stockholm (SE)

(21) Appl. No.: 13/881,086

(22) PCT Filed: Apr. 8, 2013
(86) PCT No.: PCT/SE2013/050377

§ 371 Date: Apr. 23, 2013

(51) Int. Cl. H04L 12/801; H04L 29/06

(52) U.S. Cl. CPC H04L 47/12; H04L 65/1069
USPC 709/225

(57) ABSTRACT

A TCP connection controller (10) for controlling 3-way handshakes establishing multiple TCP connections between an initiating network node and another network node is described. It includes a TCP pressure limiter (12) configured to limit TCP pressure during network congestion by reducing the rate of a TCP message type (SYN, SYN-ACK, ACK) participating in the 3-way handshakes.

### TECHNICAL FIELD

The proposed technology relates to management of TCP (Transmission Control Protocol) connections, and especially to controlling establishment of multiple TCP connections between an initiating network node and another network node.

### BACKGROUND

Web page download typically means that a large number of simultaneous TCP connections are started, where the ultimate goal is to speed up the page download time. FIG. 1 illustrates the variation over time of the number of simultaneously active TCP connections when a typical web page, such as www.facebook.com is downloaded. As illustrated in FIG. 1 the TCP pressure, i.e. the number of established TCP connections per time unit (the slope of the curve), is very high during the first second.

Many of the TCP connections transfer small amounts of data, the median object size is of the order of a few Kbytes. Nevertheless the large amount of simultaneously started TCP connections can cause problems in bottleneck link queues, since the first part of the TCP transfer is in slow start mode, which means that the TCP data rate is increased very quickly. Slow start refers to the initial ramp-up of the TCP congestion window. The congestion window is roughly doubled for each roundtrip. The term slow start is actually a bit misleading, as the congestion window increases quite rapidly. The reason for this name goes back to the early days of TCP when the congestion window immediately started from a high value. Compared to that start process slow start is considered “slow”.

The described problem may likely become even worse when it becomes more common to use larger initial congestion window sizes. The current behavior with many concurrent TCP connections is an unfortunate side effect of the fact that there is today no established mechanism to prevent and discourage such behavior, with the result that the flows will show a behavior that causes a lot of issues with excessive congestion and unfairness between users.

One solution that can be exploited is to limit the bitrate for each user. These rate throttling algorithms drop packets when the bitrate becomes too high. The problem is that the packet drop rate may become very high when a web page download is started. This can have a negative effect on e.g. VoIP (Voice over Internet Protocol) sessions that share the same bottleneck.

Another potential problem is that rate estimation algorithms can have an integration time over 1 second, meaning that by the time an overuse of bandwidth is detected, the bulk of the TCP connections has already started. For example, in FIG. 1 the peak is between 0.5 and 2.5 seconds.

### SUMMARY

An object of the proposed technology is to better control establishment of multiple TCP connections between an initiating network node and another network node.

The proposed technology involves a method of controlling 3-way handshakes establishing multiple TCP connections between an initiating network node and another network node. TCP pressure is limited during network congestion by reducing the rate of a TCP message type participating in the 3-way handshakes.

The proposed technology also involves a TCP connection controller for controlling 3-way handshakes establishing multiple TCP connections between an initiating network node and another network node. A TCP pressure limiter is configured to limit TCP pressure during network congestion by reducing the rate of a TCP message type participating in the 3-way handshakes.

The proposed technology also involves a TCP traffic shaping network node including a TCP connection controller for controlling 3-way handshakes establishing multiple TCP connections between an initiating network node and another network node. The TCP connection controller includes a TCP pressure limiter configured to limit TCP pressure during network congestion by reducing the rate of a TCP message type participating in the 3-way handshakes.

The proposed technology also involves a computer program for controlling 3-way handshakes establishing multiple TCP connections between an initiating network node and another network node. The computer program comprises computer readable code units which when run on a computer causes the computer to limit TCP pressure during network congestion by reducing the rate of a TCP message type participating in the 3-way handshakes.

An advantage of the proposed technology is that it limits the TCP pressure, i.e. the number of established TCP connections per time unit, in a way that interacts well with TCP and higher layer protocols. The technology is proactive in the sense that establishment of new TCP connections is controlled before they create problems of the type described above.

### BRIEF DESCRIPTION OF THE DRAWINGS

The proposed technology, together with further objects and advantages thereof, may best be understood by making reference to the following description taken together with the accompanying drawings, in which:

FIG. 1 is a diagram illustrating the number of simultaneously active TCP connections during a typical web page download as a function of time;

FIG. 2 is a diagram illustrating a 3-way handshake;

FIG. 3 is a flow chart illustrating the proposed method;

FIG. 4 is a flow chart illustrating an example embodiment the proposed method;

FIG. 5 is a flow chart illustrating another example embodiment the proposed method;

FIG. 6 is a flow chart illustrating another example embodiment of the proposed method;

FIG. 7 is a flow chart illustrating another example embodiment of the proposed method;

FIG. 8 is a flow chart illustrating another example embodiment of the proposed method;

FIG. 9 is a flow chart illustrating another example embodiment of the proposed method;

FIG. 10 is a flow chart illustrating another example embodiment of the proposed method;

FIG. 11 is a diagram similar to FIG. 1 illustrating a typical improvement obtained by the proposed technology;

FIG. 12 is a block diagram illustrating the proposed TCP connection controller;

FIG. 13 is a block diagram illustrating an example embodiment of the proposed TCP connection controller;

FIG. 14 is a block diagram illustrating another example embodiment of the proposed TCP connection controller;

FIG. 15 is a block diagram illustrating another example embodiment of the proposed TCP connection controller;

FIG. 16 is a block diagram illustrating another example embodiment of the proposed TCP connection controller;

FIG. 17 is a block diagram illustrating another example embodiment of the proposed TCP connection controller;

FIG. 18 is a block diagram illustrating another example embodiment of the proposed TCP connection controller;

FIG. 19 is a block diagram illustrating another example embodiment of the proposed TCP connection controller;

FIG. 20 is a block diagram illustrating an embodiment of a TCP traffic shaping network node including the proposed TCP connection controller;

FIG. 21 is a block diagram illustrating another embodiment of a TCP traffic shaping network node including the proposed TCP connection controller;

FIG. 22 is a block diagram illustrating an embodiment of a TCP traffic shaping network node including the proposed TCP connection controller; and

FIG. 23 is a block diagram illustrating another embodiment of a TCP traffic shaping network node including the proposed TCP connection controller.

### DETAILED DESCRIPTION

In the following description the same reference designations will be used for the same or similar steps/blocks.

As illustrated in FIG. 2, each new TCP connection, for example in a web page download, is initiated with a SYN (SYNchronization) message from an initiating network node (client, user terminal) to another network node (e.g. a web server). The other network node will respond with a SYN-ACK (SYNchronization ACKnowledgement) message and the initiating network node will return an ACK (ACKnowledgement) to the other network node. This procedure is known as a 3-way handshake. Thus, a 3-way handshake involves 3 message types, referred to as SYN, SYN-ACK and ACK. The SYN and ACK message types are generated by the initiating network node, whereas the SYN-ACK message type is generated by the other network node.

All the 3 message types mentioned above may get lost along the transmission path between the initiating and the other network node. For this reason timeout mechanisms have been implemented. For instance, SYN messages are retransmitted if no SYN-ACK is received within a given time interval. This interval is called the RTO (Retransmission Timeout Interval). This value is initiated to 3 seconds, see [1], but is later on adjusted depending on the measured RTT (Round Trip Time). Moreover e.g. Linux TCP stacks may initiate the RTO interval to lower values.

The basic concept of the proposed technology is to intervene in the described 3-way handshakes to reduce the rate of a TCP message type participating in the 3-way handshakes, thereby limiting the TCP pressure. This functionality may be implemented in an RNC (Radio Network Controller) in a WCDMA (Wideband Code Division Multiple Access) system. However, this is only an example. The functionality may also be implemented in other types of network nodes, as will be described below.

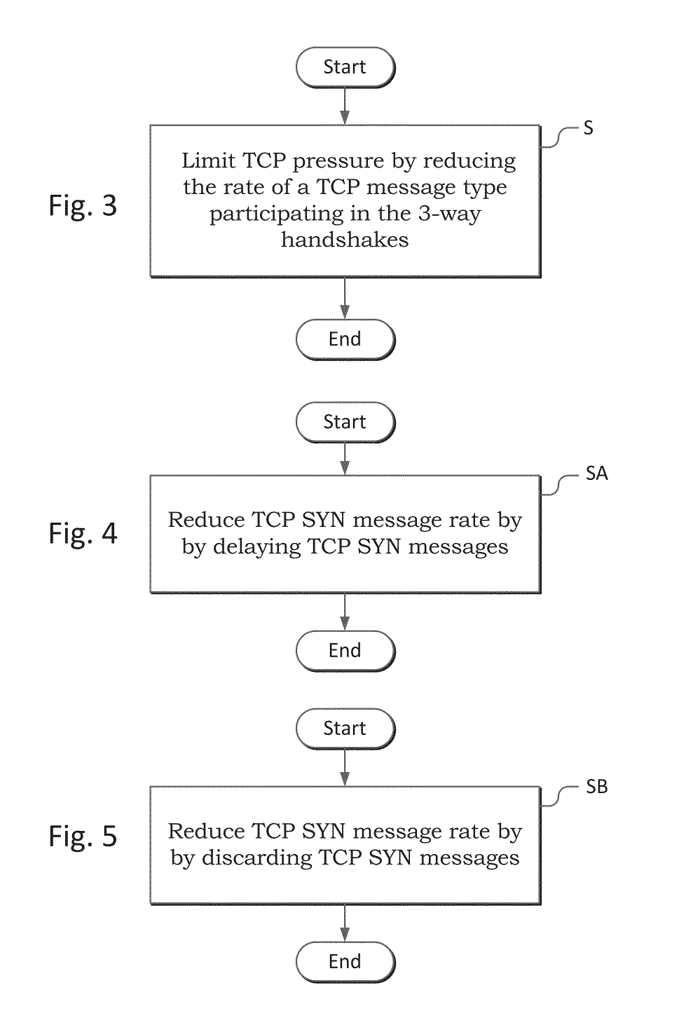

FIG. 3 is a flow chart illustrating the proposed method. During network congestion step S limits TCP pressure by reducing the rate of a TCP message type (i.e. TCP SYN, TCP SYN-ACK, TCP ACK) participating in the 3-way handshakes.

In order to simplify the presentation of the proposed technology the following description will focus on one TCP message type, namely TCP SYN messages. However, it is appreciated that TCP SYN-ACK and TCP ACK messages may be handled in a similar way.

There are several ways to reduce the TCP SYN message rate. In the example embodiment illustrated in FIG. 4 this is accomplished in step SA by delaying TCP SYN messages. In the example embodiment illustrated in FIG. 5 it is accomplished in step SB by discarding TCP SYN messages. At first it may seem that discarding SYN messages implies that some TCP connections are never established. However, it should to be remembered that SYN messages are retransmitted if no SYN-ACK is received within a given time interval, as described above. This actually gives the same technical effect as a SYN message delay.

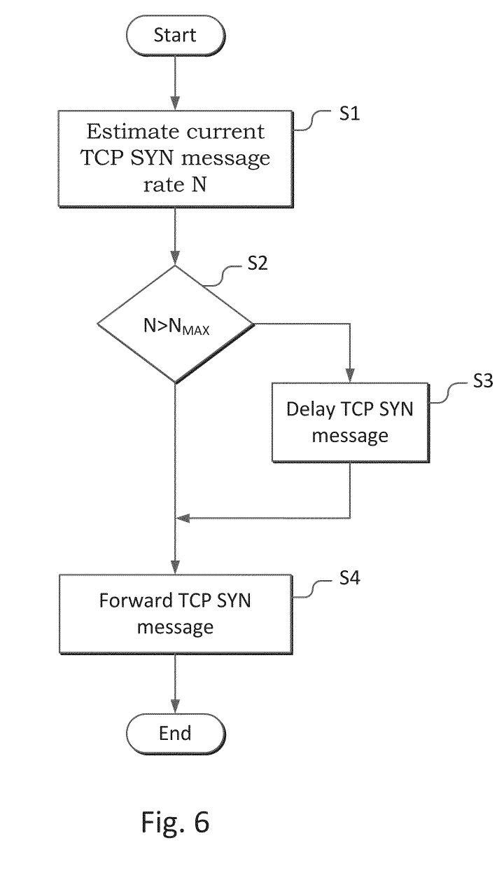

FIG. 6 is a flow chart illustrating another example embodiment of the proposed method. This embodiment is based on delaying TCP SYN messages during network congestion. The figure illustrates the steps to be performed for each TCP SYN message. Step S1 estimates the current TCP SYN message rate N. Step S2 tests whether the estimated rate N exceeds a predetermined threshold N_{MAX}. N_{MAX} can be a fixed value between 5 and 15, for example 10. If N exceeds N_{MAX}, the TCP SYN message is delayed in step S3. Otherwise it is forwarded to the other network node in step S4.

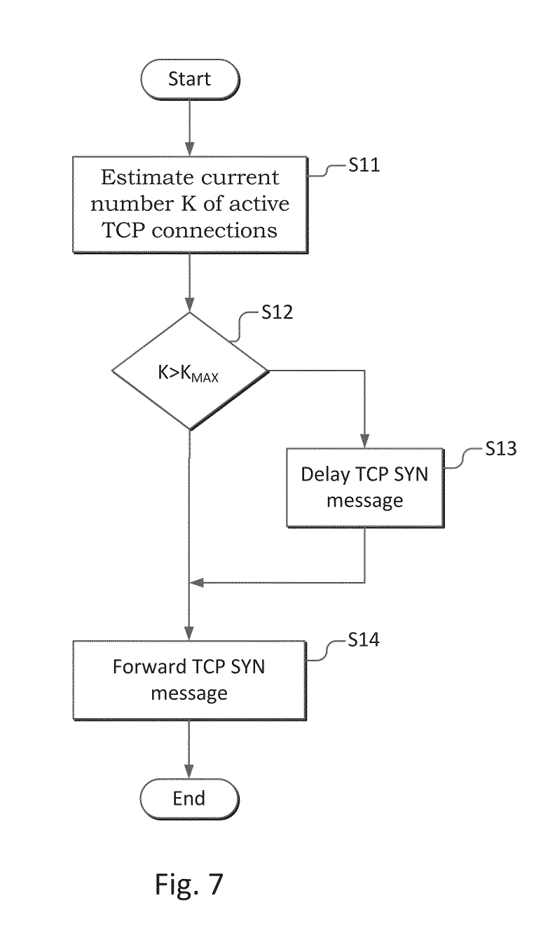

FIG. 7 is a flow chart illustrating another example embodiment of the proposed method. This embodiment is based on delaying TCP SYN messages during network congestion. The figure illustrates the steps to be performed for each TCP SYN message. Step S1l estimates the current number K of active TCP connections. K may, for example, be estimated per time unit on unique TCP 5-tuples that traverse the node where the TCP SYN rate reduction is applied. A 5-tuple is a collection of 5 values that specify the Transmission Control Protocol/Internet Protocol (TCP/IP) connection. It is formed by 5 values representing the source IP address, destination IP address, source port number, destination port number and the protocol used by the connection. Step S12 tests whether the estimated number K exceeds a predetermined threshold K_{MAX}. K_{MAX} can have a fixed value between 4 and 8, for example 6. If K exceeds K_{MAX}, the TCP SYN message is delayed in step S13. Otherwise it is forwarded to the other network node in step S14.

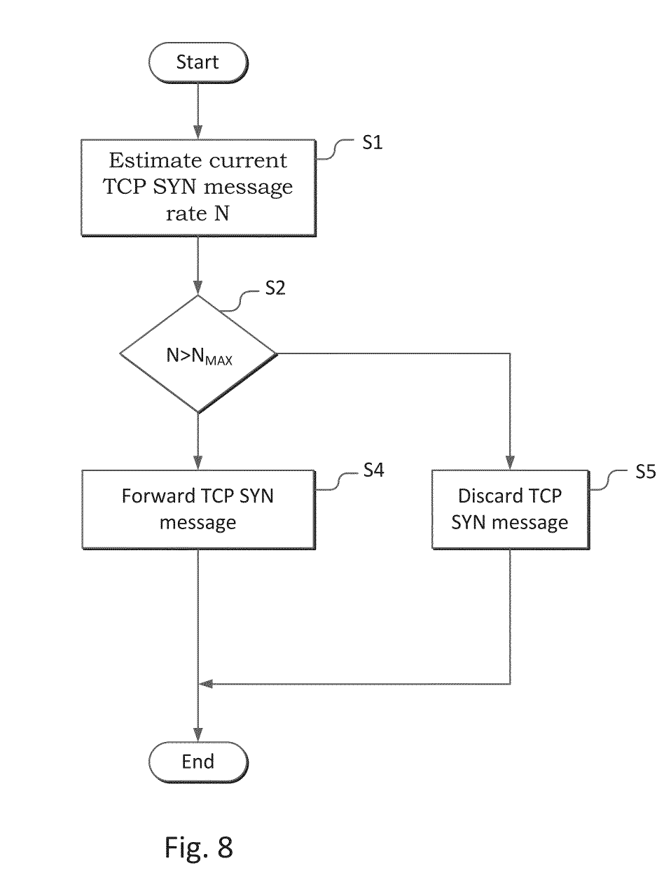

FIG. 8 is a flow chart illustrating another example embodiment of the proposed method. This embodiment is based on discarding TCP SYN messages during network congestion. The figure illustrates the steps to be performed for each TCP SYN message. Step S1 estimates the current TCP SYN message rate N. Step S2 tests whether the estimated rate N exceeds a predetermined threshold N_{MAX}. N_{MAX} can be a fixed value between 5 and 15, for example 10. If N exceeds N_{MAX}, the TCP SYN message is discarded in step S5. Otherwise it is forwarded to the other network node in step S4.

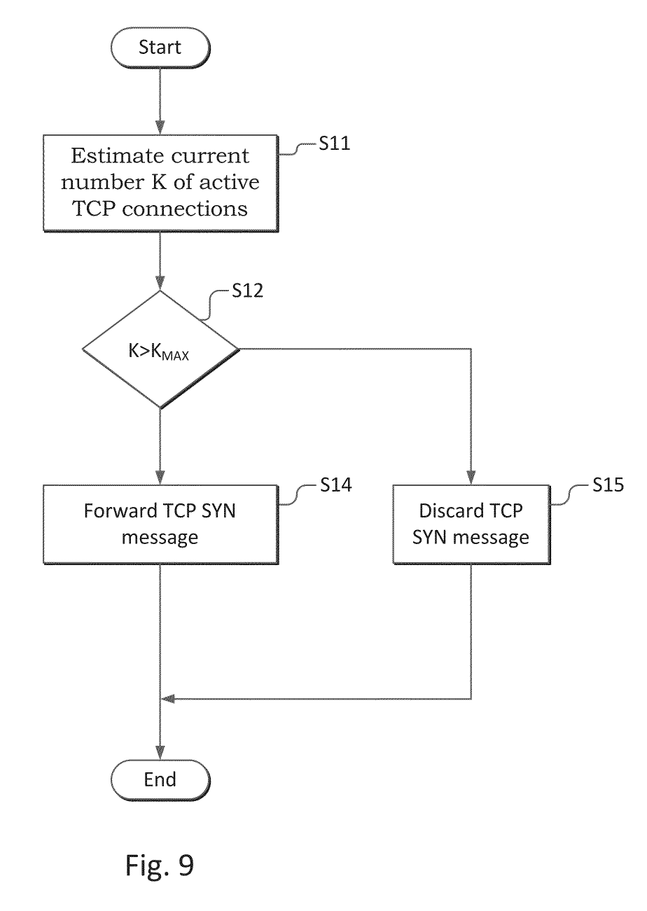

FIG. 9 is a flow chart illustrating another example embodiment of the proposed method. This embodiment is based on discarding TCP SYN messages during network congestion. The figure illustrates the steps to be performed for each TCP SYN message. Step S1l estimates the current number K of active TCP connections. Step S12 tests whether the estimated number K exceeds a predetermined threshold K_{MAX}. K_{MAX} can have a fixed value between 4 and 8, for example 6. If K exceeds K_{MAX}, the TCP SYN message is discarded in step S15. Otherwise it is forwarded to the other network node in step S14.

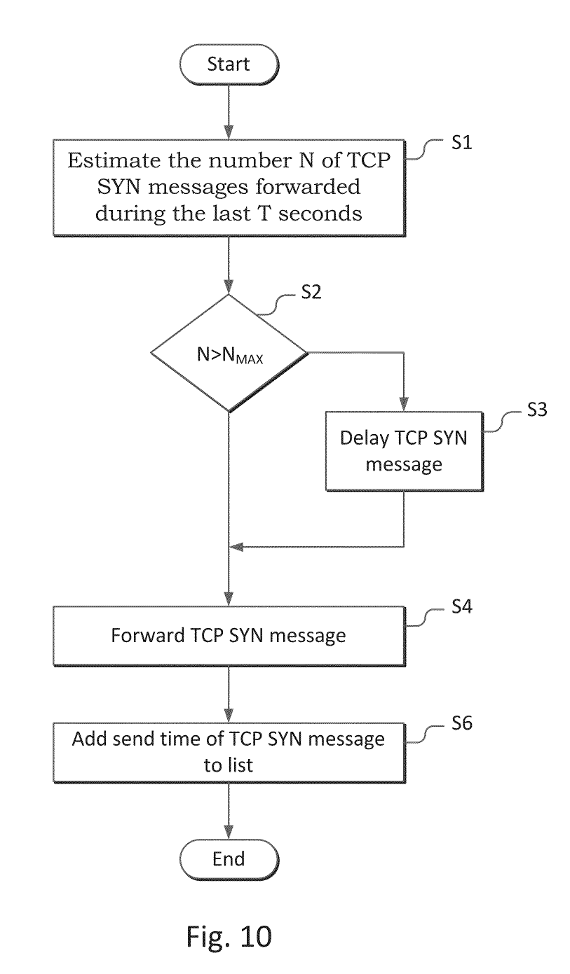

FIG. 10 is a flow chart illustrating another example embodiment the proposed method. This embodiment is based on delaying TCP SYN messages during network congestion. The figure illustrates the steps to be performed for each TCP SYN message. This embodiment is based on keeping a list of send times for recent TCP SYN messages. Step S1 uses this list to estimate the number N of TCP SYN messages forwarded during the last T seconds. The value of T can be set to a value between 0.5 and 2s, for example 1s. Step S2 tests whether the estimated N exceeds a predetermined threshold N_{MAX}. N_{MAX} can be fixed value between 5 and 15, for example 10. If N exceeds the predetermined threshold N_{MAX}, the TCP SYN message is delayed in step S3. Otherwise it is forwarded to the other network node in step S4. Step S6 adds the send time of the TCP SYN message to the list. In a similar embodiment step S3 may be replaced by a discarding step instead of a delaying step.

If the initiating network node is a central node (not end node), such as an RNC, receiving TCP SYN messages from several users, a separate list of send times may be generated for each user. In such a case each new TCP SYN message is associated with its corresponding list. Furthermore, each user may be allocated an individual threshold (N_{MAX}, K_{MAX}).

Although the embodiments of FIG. 4-10 have been described with reference to TCP SYN messages, similar embodiments may be used for TCP SYN-ACK and TCP ACK messages. Thus, it is possible to both delay and discard TCP SYN-ACK and TCP ACK messages to reduce the respective message rate. In the embodiments where a TCP SYN-ACK message is discarded, a new TCP SYN-ACK message will be transmitted after a predetermined time interval. In the embodiments where a TCP ACK message is discarded, the 3-way handshake is considered incomplete, which after a predetermined time interval results in transmission (from the “other” network node) of a new TCP SYN-ACK message requesting a TCP ACK message. This has the same technical effect as a delay. Before delaying/discarding a TCP ACK message it should preferably be checked that the ACK actually is associated with a 3-way handshake. This can be done by checking (for each 3-way handshake) that a SYN has been transmitted and a SYN-ACK has been received.

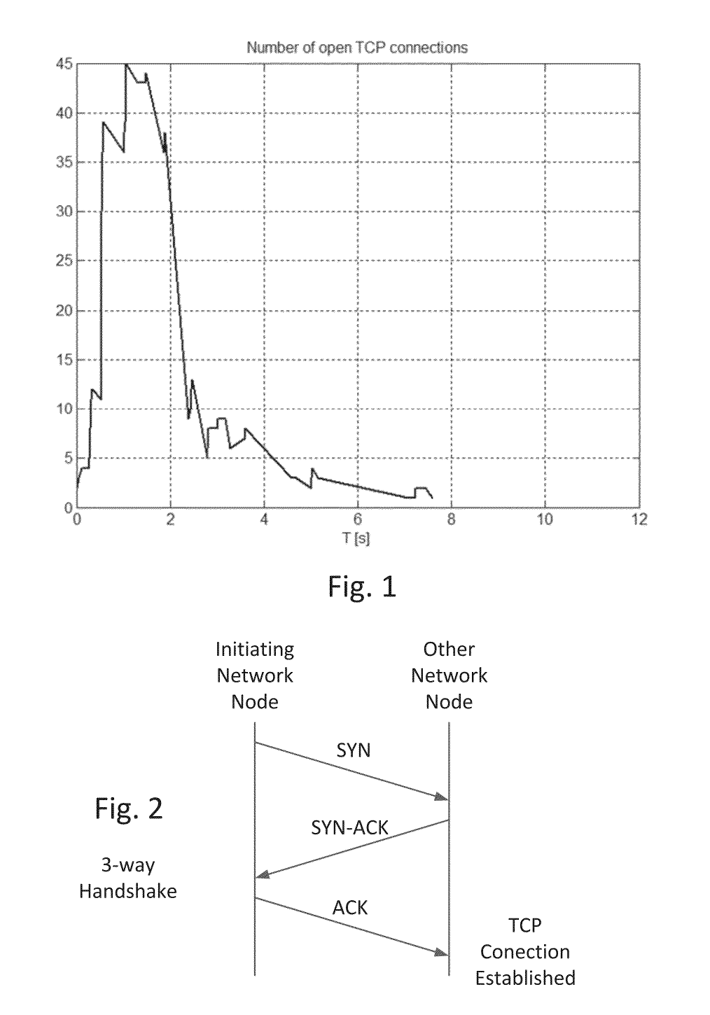

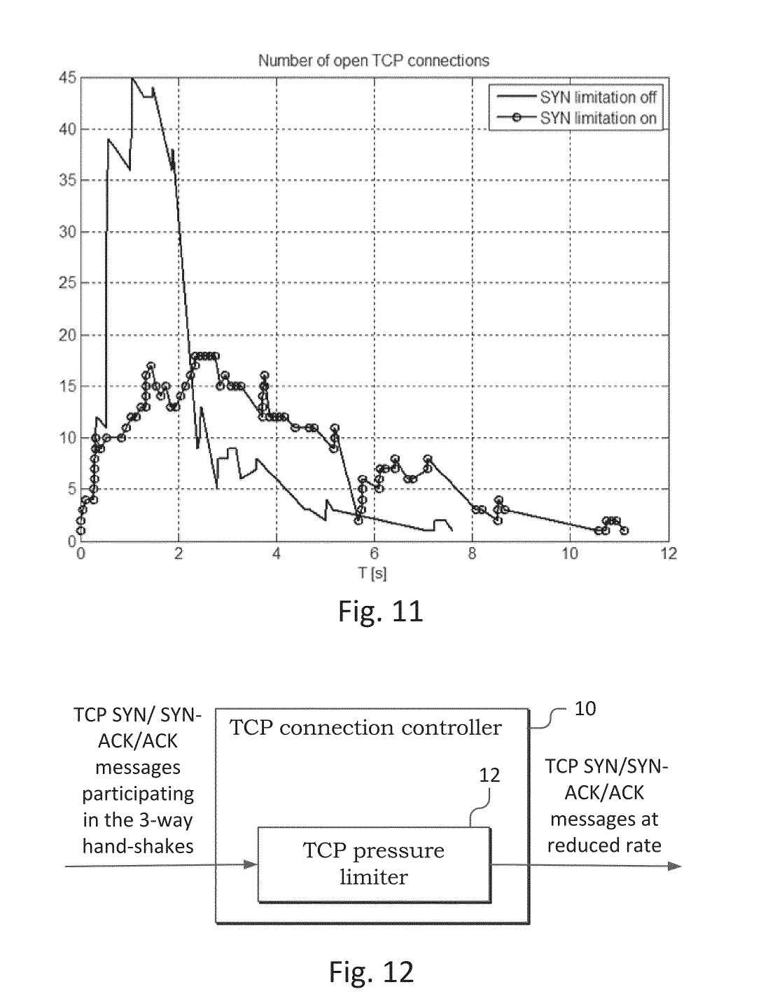

FIG. 11 is a diagram similar to FIG. 1 illustrating typical improvements obtained by the proposed technology. In essence it limits the TCP pressure, and in particular the number of TCP connections that are simultaneously established in TCP slow start mode during data link congestion. The figure may give the impression that the web page download is slower. This is, however, typically not be the case. This is because no matter how many concurrent TCP connections that are established, they still have to compete for the same limited bandwidth. The proposed technology also has the side effect that it discourages the behavior to simultaneously start many TCP connections. A positive effect of the proposed technology is also that it reduces the amount of queued packets in the network nodes, especially in the startup phase. This leads to a lower risk of excessive delays or packet losses and ultimately also to a lower risk of retransmission timeout.

FIG. 12 is a block diagram illustrating the proposed A TCP connection controller 10 for controlling 3-way handshakes establishing multiple TCP connections between an initiating network node and another network node. It includes a TCP pressure limiter 12 receiving TCP messages of a type (i.e. TCP SYN/SYN-ACK/ACK) that participates in the 3-way handshakes. The TCP pressure limiter 12 is configured to limit TCP pressure during network congestion by reducing the rate of these TCP messages.

The following description of specific embodiments will focus on TCP SYN messages. However, as already noted above similar embodiments may be used for TCP SYN-ACK and TCP ACK messages.

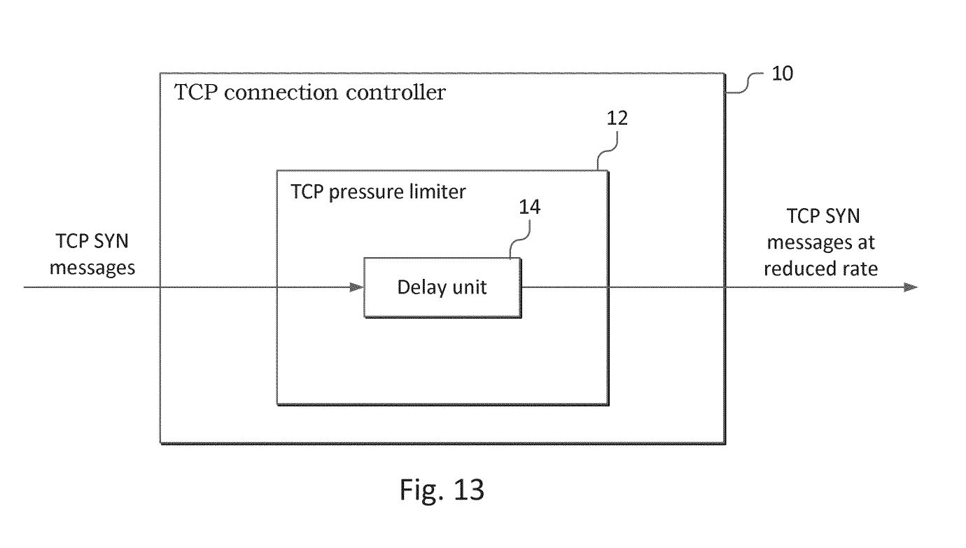

There are several ways to reduce the TCP SYN message rate in the TCP pressure limiter 12. In one example embodiment, illustrated in FIG. 13, the TCP pressure limiter 12 includes a delay unit 14 configured to reduce the TCP SYN message rate by delaying TCP SYN messages.

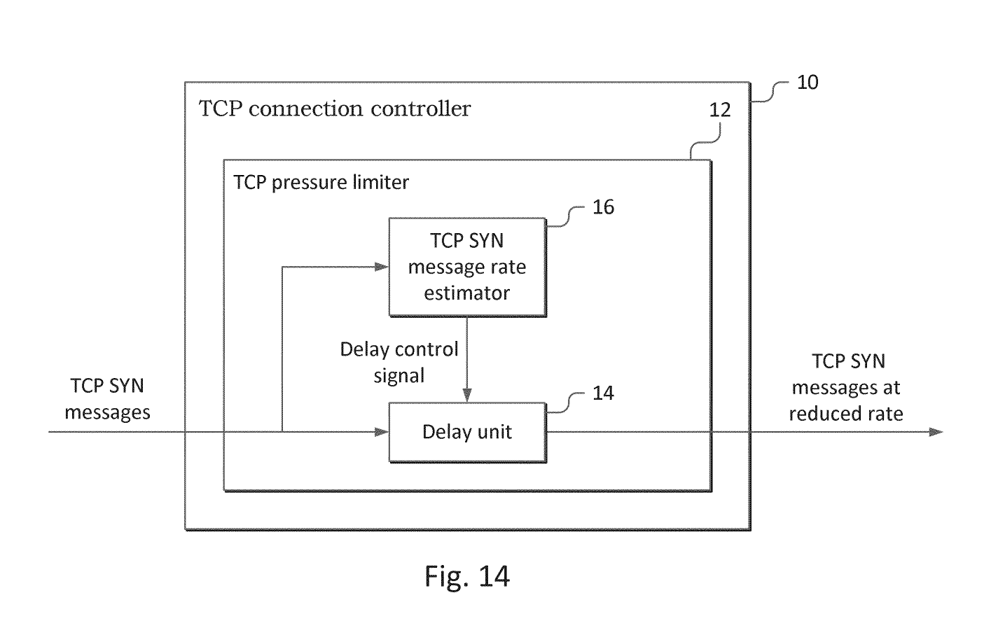

FIG. 14 is a block diagram illustrating another example embodiment of the proposed TCP connection controller. In this embodiment the TCP pressure limiter 12 includes a TCP SYN message rate estimator 16 configured to estimate a current TCP SYN message rate N. Furthermore, the delay unit 14 is configured to delay a TCP SYN message by a predetermined time period if the estimated current TCP SYN message rate N exceeds a predetermined TCP SYN message rate threshold N_{MAX}. N_{MAX} may be selected as described above. The decision whether the rate N exceeds the threshold N_{MAX} may be performed by the TCP SYN message rate estimator 16, which sends a corresponding delay control signal to the delay unit 14. The TCP SYN message rate estimator 16 may, for example, be configured to estimate the current TCP SYN message rate N as described with reference to FIG. 10.

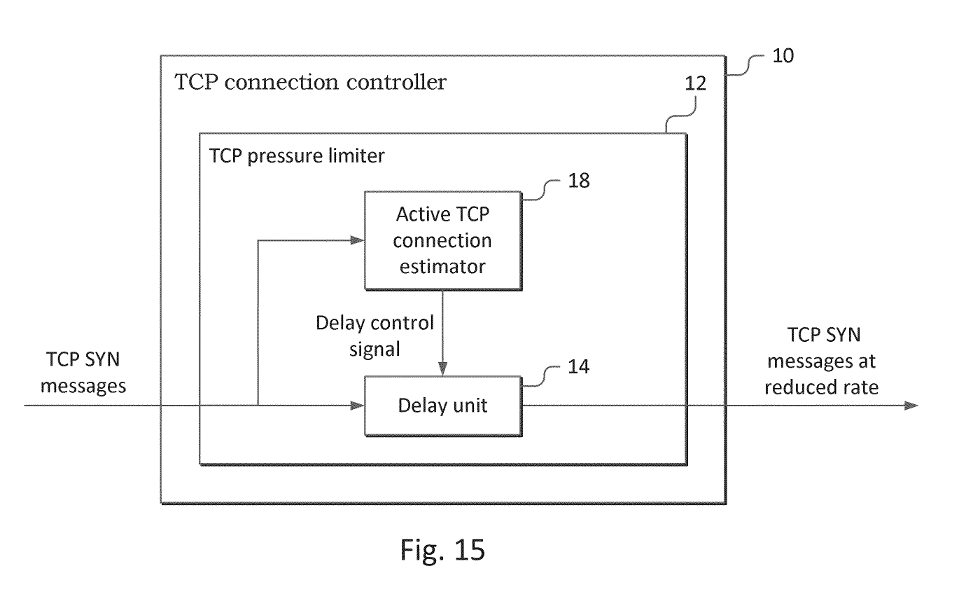

FIG. 15 is a block diagram illustrating another example embodiment of the proposed TCP connection controller. In this embodiment the TCP pressure limiter 12 includes an active TCP connection estimator 18 configured to estimate a current number K of active TCP connections. Furthermore, the delay unit 14 is configured to delay a TCP SYN message by a predetermined time period if the estimated current number K of active TCP connections exceeds a predetermined active connections threshold K_{MAX}. K_{MAX} may be selected as described above. The decision whether the rate K exceeds the threshold K_{MAX} may be performed by the active TCP connection estimator 18, which sends a corresponding delay control signal to the delay unit 14.

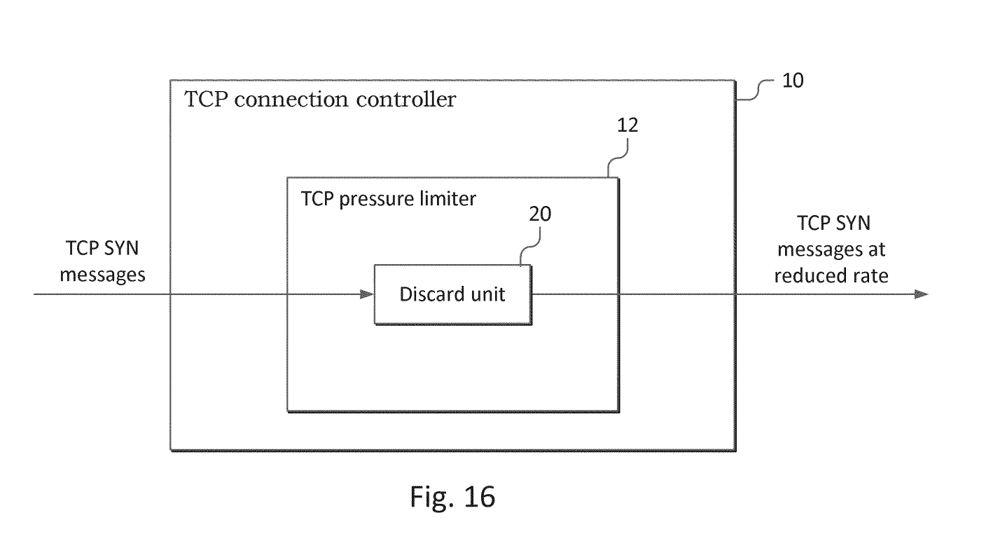

Another way to reduce the TCP SYN message rate in TCP pressure limiter 12 is illustrated in FIG. 16. In this example embodiment the TCP pressure limiter 12 includes a discard unit 20 configured to reduce the TCP SYN message rate by discarding TCP SYN messages. As noted above, in this case SYN messages are retransmitted if no SYN-ACK is received within a given time interval.

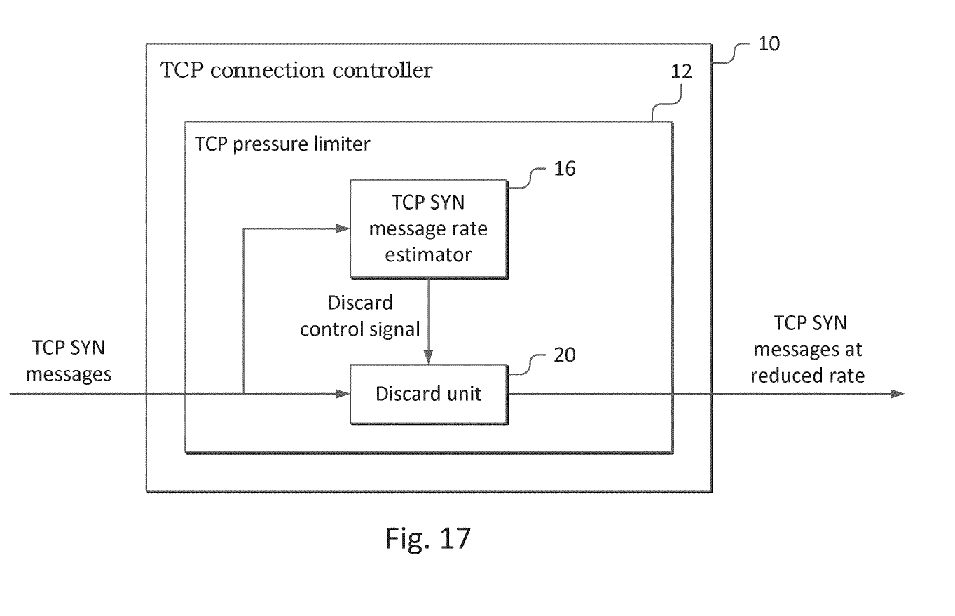

FIG. 17 is a block diagram illustrating another example embodiment of the proposed TCP connection controller. In this embodiment the TCP pressure limiter 12 includes a TCP SYN message rate estimator 16 configured to estimate a current TCP SYN message rate N. Furthermore, the discard unit 20 is configured to discard a TCP SYN message if the estimated current TCP SYN message rate N exceeds a predetermined TCP SYN message rate threshold N_{MAX}. N_{MAX} may be selected as described above. The decision whether the rate N exceeds the threshold N_{MAX} may be performed by the TCP SYN message rate estimator 16, which sends a corresponding discard control signal to the discard unit 20. The TCP SYN message rate estimator 16 may, for example, be configured to estimate the current TCP SYN message rate N as described with reference to FIG. 10.

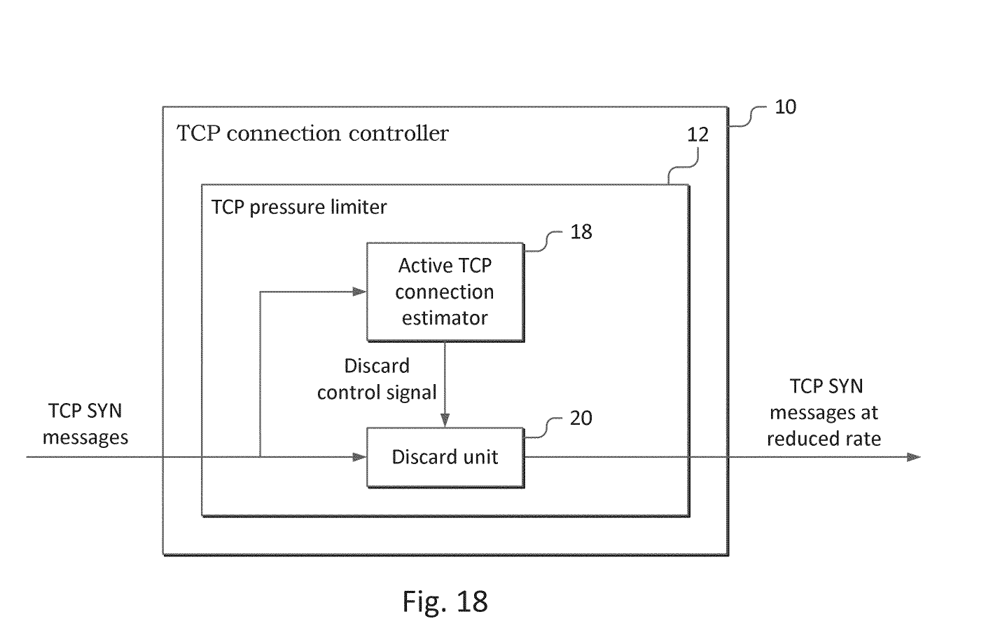

FIG. 18 is a block diagram illustrating another example embodiment of the proposed TCP connection controller. In this embodiment the TCP pressure limiter 12 includes an active TCP connection estimator 18 configured to estimate a current number K of active TCP connections. Furthermore, the discard unit 20 is configured to discard a TCP SYN message if the estimated current number K of active TCP connections exceeds a predetermined active connections threshold K_{MAX}. K_{MAX} may be selected as described above. The decision whether the rate K exceeds the threshold K_{MAX} may be performed by the active TCP connection estimator 18, which sends a corresponding discard control signal to the discard unit 14.

The steps, functions, procedures and/or blocks described herein may be implemented in hardware using any conventional technology, such as discrete circuit or integrated circuit technology, including both general-purpose electronic circuitry and application-specific circuitry.

Alternatively, at least some of the steps, functions, procedures and/or blocks described herein may be implemented in software for execution by suitable processing equipment. This equipment may include, for example, one or several micro processors, one or several Digital Signal Processors (DSP), one or several Application Specific Integrated Circuits (ASIC), video accelerated hardware or one or several suitable programmable logic devices, such as Field Programmable Gate Arrays (FPGA). Combinations of such processing elements are also feasible.

It should also be understood that it may be possible to reuse the general processing capabilities already present in the initiating network node. This may, for example, be done by reprogramming of the existing software or by adding new software components.

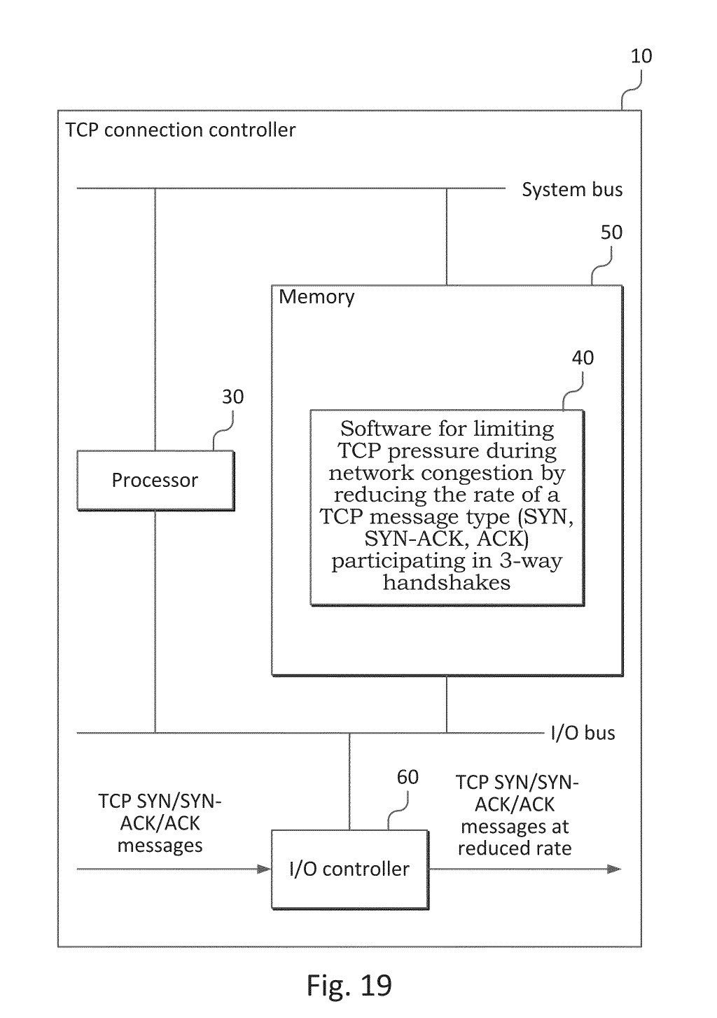

FIG. 19 is a block diagram illustrating another example embodiment of the proposed TCP connection controller 10. This embodiment is based on a processor 30, for example a micro processor, which executes software 40 for limiting TCP pressure during network congestion by reducing the rate of a TCP message type (SYN, SYN-ACK, ACK) participating in the 3-way handshakes. The software is stored in memory 50. The processor 30 communicates with the memory over a system bus. The incoming TCP messages are received by an input/output (I/O) controller 60 controlling an I/O bus, to which the processor 30 and the memory 50 are connected. The TCP messages at reduced rate obtained from the software 40 are outputted from the memory 50 by the I/O controller 60 over the I/O bus.

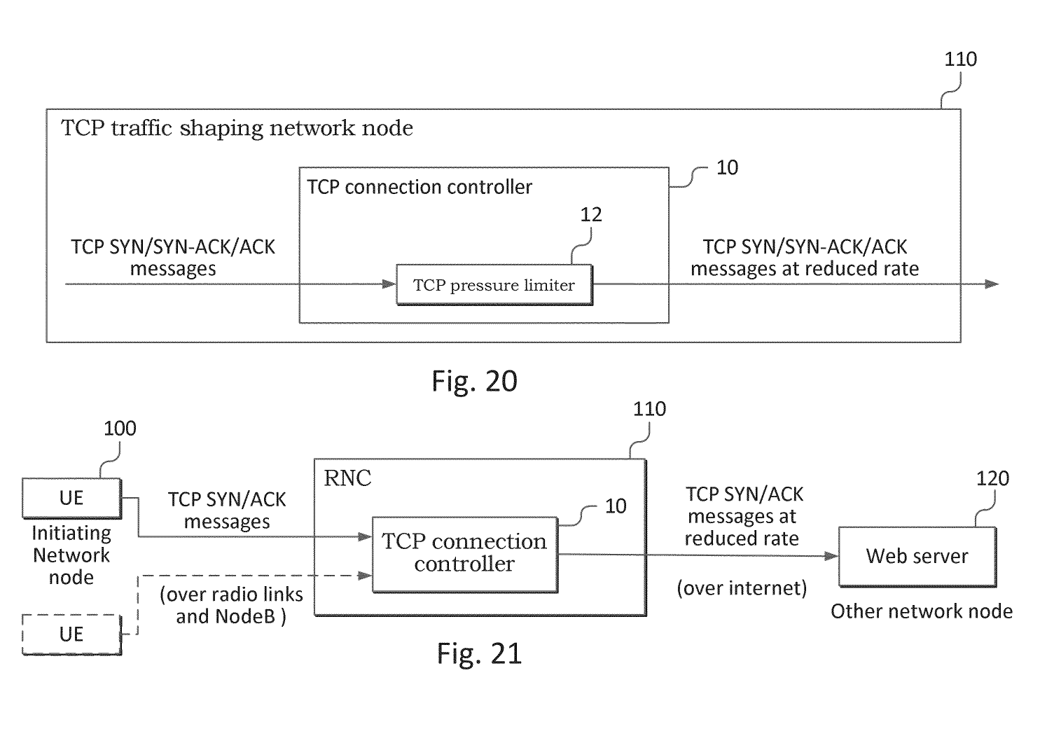

As illustrated in FIG. 20 the proposed technology also involves a TCP traffic shaping network node 110 having a TCP connection controller 10 for controlling 3-way handshakes establishing multiple TCP connections between an initiating network node and another network node. The TCP connection controller 10 includes a TCP pressure limiter 12 configured to limit TCP pressure during network congestion by reducing the rate of a TCP message type (SYN, SYN-ACK, ACK) participating in the 3-way handshakes.

A few use cases involving different TCP traffic shaping network nodes will now be described. They all describe the case where the TCP traffic in the downlink is limited by reducing the TCP SYN message rate in the uplink. However, the idea can also be used to limit the TCP traffic in the uplink.

One use case relates to the WCDMA transport network between an RNC and a NodeB (a logical node handling transmission/reception in multiple cells, commonly, but not necessarily, corresponding to a base station). The background is an identified problem in the transport link between the RNC and NodeB, which may become congested. The result of such congestion is that retransmissions will occur on the RLC (Radio Link Control) layer, which will create an even higher load on the transport network. This problem can be reduced by providing the proposed TCP connection controller in the RNC, as illustrated in FIG. 21.

In the use case illustrated in FIG. 21 an initiating network node formed by a UE (User Equipment) 100 is connected to an RNC 110 (the “TCP traffic shaping network node” in this use case) over a radio link and a NodeB. The UE may be understood as any communication enabled device, such as household appliances, vehicles, meters, multimedia devices, medical appliances, computers, smartphones, etc. The RNC 110 includes the proposed TCP connection controller 10, which receives TCP SYN messages from the UE 100. During network congestion TCP SYN (or ACK) messages at a reduced rate are forwarded to the other network node, in this case a web server 120, over the Internet. As illustrated in FIG. 21 the RNC 110 may receive TCP SYN (or ACK) messages from several UEs (indicated by the UE in dashed lines). In such a case each UE will be handled separately.

In an LTE (Long-Term Evolution) system the sudden rush given by simultaneously started TCP connections is complex to handle by AQM (Active Queue Management) in the eNodeB (similar to a NodeB with added (“evolved”) functionality). In this case a TCP connection controller 10 may be provided in the eNodeB to form a TCP traffic shaping network node.

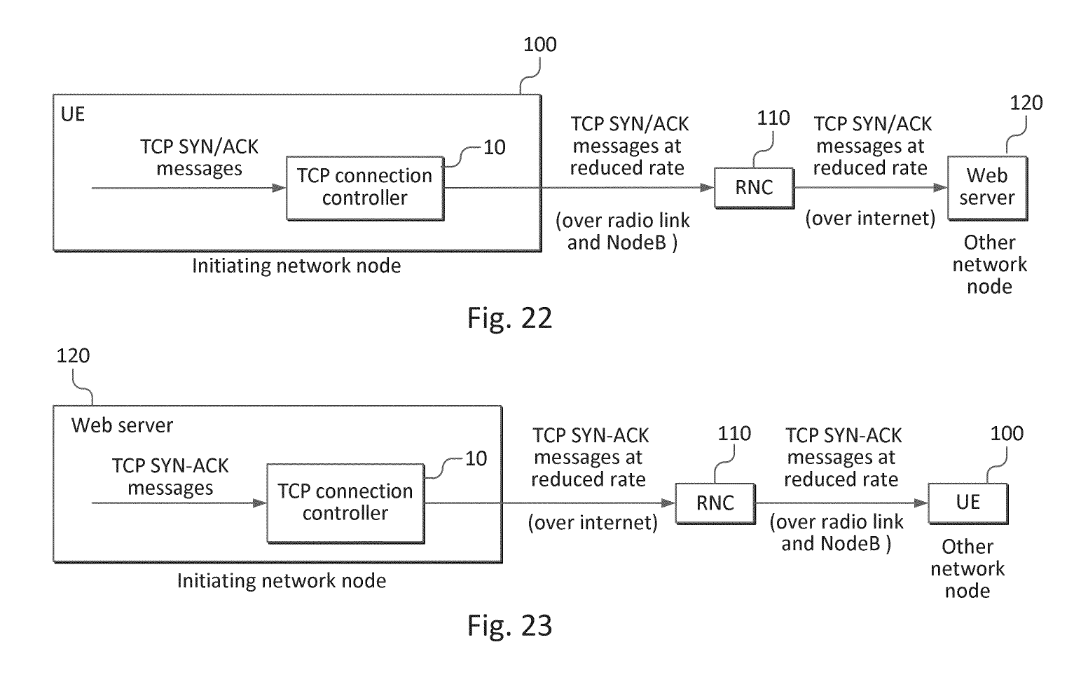

In the use case illustrated in FIG. 22 the TCP traffic shaping network node is the UE 100 itself. In this example TCP SYN (or ACK) messages generated in the UE are forwarded to a TCP connection controller 10 provided directly in the UE. Thus, the TCP SYN (or ACK) message rate is reduced in the UE 100.

In the use case illustrated in FIG. 23 the TCP traffic shaping network node is the web server 120. In this example TCP SYN-ACK messages generated in the web server are forwarded to a TCP connection controller 10 provided directly in the web server. Thus, the TCP SYN-ACK message rate is reduced in the web server 120.

Examples of other TCP traffic shaping network nodes where a TCP connection controller 10 may be provided are routers and gateways, for example PGWs (Packet data network GateWays).

In the description above the thresholds N_{MAX} and K_{MAX} have been assumed to be fixed. In more elaborate embodiments they may be dynamical thresholds. For example, N_{MAX} and/or K_{MAX} can be made dependent on the overall system load. Metrics that can be used to determine N_{MAX} and/or K_{MAX} include downlink transmission power, estimated round trip time (RTT), transport network capacity, transport network congestion, available processing resources, etc. Moreover N_{MAX} and/or K_{MAX} can be dependent on e.g. channel quality on a per wireless terminal basis. The thresholds N_{MAX} and/or K_{MAX} may, for example, be raised or lowered by a constant depending on the current value of one or a combination of these parameters.

Network congestion may, for example, be detected by monitoring indicators such as frame loss rate in a NodeB (or equivalent). It is also possible to track traffic on the transport network to see whether a predetermined maximum capacity has been reached. Another alternative is to compare the current transport network traffic to earlier measured traffic where excessive transport network frame loss was detected. In a radio base station there is one buffer per radio access bearer (mac-d flow). During air interface congestion this buffer may be filled. Thus, the level of filling of this buffer may be used as an indicator of network congestion. Still another indicator is channel quality. The proposed technology has been described with reference to downloading of web pages. However, this is only one example. The same technology may generally be used in applications where many TCP sessions are active at the same time. Another example is peer-to-peer (P2P) traffic with many TCP sessions.

It will be understood by those skilled in the art that various modifications and changes may be made to the proposed technology without departure from the scope thereof, which is defined by the appended claims.

### ABBREVIATIONS

ACK ACKnowledgement
AQM Active Queue Management
ASIC Application Specific Integrated Circuit
DSP Digital Signal Processor
FPGA Field Programmable Gate Arrays
IP Internet Protocol
LTE Long-Term Evolution
P2P Peer-to-Peer
PGW Packet data network GateWay
RLC Radio Link Control
RNC Radio Network Controller
RTO Retransmission Timeout Interval
RTT Round Trip Time
SYN SYNchronization
SYN-ACK SYNchronization ACKnowledgement
TCP Transmission Control Protocol
UE User Equipment
VoIP Voice over Internet Protocol
WCDMA Wideband Code Division Multiple Access

### REFERENCE

[1] RFC 1122 “Requirements for Internet Hosts—Communication Layers”, www.tools.ietf.org/html/rfc1122, 1989, Chapter 4.2.3.1 and 4.2.3.5.

1-32. (canceled)

33. A method of controlling 3-way handshakes establishing multiple TCP connections between an initiating network node and another network node, said method comprising:
limiting TCP pressure during network congestion by reducing the rate of a TCP message type participating in the 3-way handshakes.

34. The method of claim 33, wherein reducing the rate comprises reducing a TCP SYN message rate.

35. The method of claim 34, wherein the TCP SYN message rate is reduced by delaying TCP SYN messages.

36. The method of claim 35, further comprising:
estimating a current TCP SYN message rate; and
delaying a TCP SYN message by a predetermined time period, if the estimated current TCP SYN message rate exceeds a predetermined TCP SYN message rate threshold.

37. The method of claim 36, wherein the predetermined TCP SYN message rate threshold comprises a dynamical predetermined TCP SYN message rate threshold.

38. The method of claim 35, further comprising:
estimating a current number of active TCP connections; and
delaying a TCP SYN message by a predetermined time period if the estimated current number of active TCP connections exceeds a predetermined active connections threshold.

39. The method of claim 38, wherein the predetermined active connections threshold comprises a dynamical predetermined active connections threshold.

40. The method of claim 34, wherein the TCP SYN message rate is reduced by discarding TCP SYN messages.

41. The method of claim 40, further comprising:
estimating a current TCP SYN message rate; and
discarding a TCP SYN message if the estimated current TCP SYN message rate exceeds a predetermined TCP SYN message rate threshold.

42. The method of claim 40, further comprising:
estimating a current number of active TCP connections; and
discarding a TCP SYN message if the estimated current number of active TCP connections exceeds a predetermined active connections threshold.

43. The method of claim 33, wherein reducing the rate of the TCP message type participating in the 3-way handshakes comprises reducing a TCP SYN-ACK message rate.

44. The method of claim 33, wherein reducing the rate of the TCP message type participating in the 3-way handshakes comprises reducing a TCP ACK message rate.

45. A TCP connection controller for controlling 3-way handshakes establishing multiple TCP connections between an initiating network node and another network node, said TCP connection controller comprising:
a TCP pressure limiter configured to limit TCP pressure during network congestion by reducing the rate of a TCP message type participating in the 3-way handshakes.

46. The TCP connection controller of claim 45, wherein the TCP pressure limiter is configured to reduce a TCP SYN message rate.

47. The TCP connection controller of claim 46, wherein the TCP pressure limiter includes a delay unit configured to reduce the TCP SYN message rate by delaying TCP SYN messages.

48. The TCP connection controller of claim 47, wherein the TCP pressure limiter includes:
a TCP SYN message rate estimator configured to estimate a current TCP SYN message rate; and
wherein the delay unit is configured to delay a TCP SYN message by a predetermined time period if the estimated current TCP SYN message rate exceeds a predetermined TCP SYN message rate threshold.

49. The TCP connection controller of claim 47, wherein the TCP pressure limiter includes:
an active TCP connection estimator configured to estimate a current number of active TCP connections; and
wherein the delay unit is configured to delay a TCP SYN message by a predetermined time period if the estimated current number of active TCP connections exceeds a predetermined active connections threshold.

50. The TCP connection controller of claim 46, wherein the TCP pressure limiter includes a discard unit configured to reduce the TCP SYN message rate by discarding TCP SYN messages.

51. The TCP connection controller of claim 50, wherein the TCP pressure limiter includes:
a TCP SYN message rate estimator configured to estimate a current TCP SYN message rate; and
wherein the discard unit is configured to discard a TCP SYN message if the estimated current number of active TCP connections exceeds a predetermined active connections threshold.

52. The TCP connection controller of claim 50, wherein the TCP pressure limiter includes:
an active TCP connection estimator configured to estimate a current number of active TCP connections; and
wherein the discard unit is configured to discard a TCP SYN message if the estimated current number of active TCP connections exceeds a predetermined active connections threshold.

53. The TCP connection controller of claim 45, wherein the TCP pressure limiter is configured to reduce TCP SYN-ACK message rate.

54. The TCP connection controller of claim 45, wherein the TCP pressure limiter is configured to reduce TCP ACK message rate.

55. A TCP traffic shaping network node that includes by a TCP connection controller for controlling 3-way handshakes establishing multiple TCP connections between an initiating network node and another network node, wherein the TCP connection controller comprises:
a TCP pressure limiter configured to limit TCP pressure during network congestion by reducing the rate of a TCP message type participating in the 3-way handshakes.

56. The TCP traffic shaping network node of claim 55, wherein the network node is a radio network controller.

57. The TCP traffic shaping network node of claim 55, wherein the network node is a router.

58. The TCP traffic shaping network node of claim 55, wherein the network node is a gateway.

59. The TCP traffic shaping network node of claim 55, wherein the network node is a user equipment.

60. The TCP traffic shaping network node of claim 55, wherein the network node is an eNodeB.

61. The TCP traffic shaping network node of claim 55, wherein the network node is a NodeB.

62. The TCP traffic shaping network node of claim 55, wherein the network node is a web server.

63. A computer readable medium storing a computer program for controlling 3-way handshakes establishing multiple TCP connections between an initiating network node and another network node, said computer program comprising computer readable code units which, when executed by a computer, causes the computer to limit TCP pressure during network congestion by reducing the rate of a TCP message type participating in the 3-way handshakes.
